(19) United States
(12) Patent Application Publication
(10) Pub. No.: US 2012/0210373 A1
(43) Pub. Date: Aug. 16, 2012

(54) SESSION SYNCHRONIZATION OF INACTIVE IPTV DEVICE WITH SECOND DISPLAY DEVICE

(75) Inventors: Ling Jun Wong, Escondido, CA (US); True Xiong, San Diego, CA (US); Charles McCoy, Coronado, CA (US); Leo Pedlow, Ramona, CA (US)

(73) Assignees: Sony Network Entertainment International LLC, Los Angeles, CA (US); Sony Corporation, Tokyo (JP)

(21) Appl. No.: 13/073,870

(22) Filed: Mar. 28, 2011

Related U.S. Application Data
(60) Provisional application No. 61/442,161, filed on Feb. 11, 2011.

(51) Int. Cl. H04N 7/173; H04N 7/18

(52) U.S. Cl. 725/80; 725/110

(57) ABSTRACT

Synchronizing a session of an inactive first device with a second device, including: generating a temporary session for the second device when the first device configured as an IPTV client becomes inactive; associating the temporary session with the inactive IPTV client to allow the second device to continue transactions while the IPTV client is inactive; searching for the temporary session associated with the IPTV client when the IPTV client becomes active again; and assigning the temporary session to the IPTV client. Keywords include session synchronization and transfer credentials.

### CROSS-REFERENCE TO RELATED APPLICATIONS

This application claims the benefit of priority of co-pending U.S. Provisional Patent Application No. 61/442,161, filed Feb. 11, 2011, entitled “Session Synchronization of Inactive IPTV Device with Second Display Device.” The disclosure of the above-referenced patent application is incorporated herein by reference.

### BACKGROUND

1. Field of the Invention

The present invention relates to IPTV devices, and more specifically, to a session synchronization of an inactive IPTV device with a second device.

2. Background

Internet video services such as Bravia Internet Video Link (BIVL) enable users to browse and search content on the Internet. The browsing and searching can be done using Internet Protocol television (IPTV) which uses the architecture and networking methods of the Internet Protocol Suite over a packet-switched network infrastructure.

The popularity of the IPTV can be increased by providing a solution to the difficulty of navigating around (e.g., browsing and searching BIVL content) a main display without disturbing the viewing experience of other users who are watching the main display. However, there are issues of cumbersome data entry, limitations in memory and processing power, and difficulties in effective content searches.

### SUMMARY

The present invention provides for synchronizing a session of an inactive first device with a second device.

In one implementation, a method of synchronizing session of an inactive first device with a second device is disclosed. The method includes: generating a temporary session for the second device when the first device configured as an IPTV client becomes inactive; associating the temporary session with the inactive IPTV client to allow the second device to continue transactions while the IPTV client is inactive; searching for the temporary session associated with the IPTV client when the IPTV client becomes active again; and assigning the temporary session to the IPTV client.

In another implementation, a non-transitory storage medium storing a computer program for synchronizing a session of an inactive first device with a second device is disclosed. The computer program includes executable instructions that cause a computer to: generate a temporary session for the second device when the first device configured as an IPTV client becomes inactive; associate the temporary session with the inactive IPTV client to allow the second device to continue transactions while the IPTV client is inactive; search for the temporary session associated with the IPTV client when the IPTV client becomes active again; and assign the temporary session to the IPTV client.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a flowchart illustrating a process for synchronizing a session of an inactive IPTV client with a second device in accordance with one implementation of the present invention.

FIG. 2 shows a content transaction system configured to enabling a user browsing media content on one device to have the selection played by another device.

FIG. 3A illustrates a representation of a computer system and a user.

FIG. 3B is a functional block diagram illustrating the computer system hosting a session synchronizer.

### DETAILED DESCRIPTION

Certain implementations as disclosed herein provide for enabling a user browsing media content (e.g., BIVL content) on one device (e.g., a second device) to have the selection played by another device (e.g., a main device such as an IPTV client). The user can then continue to browse the media content on any number of additional devices without interrupting the content that is being played on the main device.

After reading this description it will become apparent how to implement the invention in various implementations and applications. However, although various implementations of the present invention will be described herein, it is understood that these implementations are presented by way of example only, and not limitation. As such, this detailed description of various implementations should not be construed to limit the scope or breadth of the present invention.

In one implementation, a second device, such as cellphones, laptops, and other portable devices, which are already owned by most users, is used to browse and search media content, and then have the selected content played on a main device a, big screen IPTV for convenient viewing). The user can then continue to browse and search the media content on the second device without interrupting the content that is being played on the main device. In some implementations, the browsing and searching can be done on any number of additional devices. For example, while the selected content is being played on the main device for first user (along with other viewers), a second user can use a second device to browse, search, select, and reserve the media content for next play on the main device, and a third user can use a third device to browse and search the media content.

However, by requiring that the user send the selected media content for playback on the IPTV client only when the user is ready to watch the content, the security risks can be substantially reduced because the playback of proprietary media content occurs only on the authenticated IPTV client rather than on a non-authenticated second device. Since the web application of the second device is usually written in HTML, it can be loaded by any device with a browser. It should be noted that the web application need not necessarily be written in HTML but in any browser-supported language such as Java Script and/or other markup languages. Further, in an alternative, the user can use a native application already installed on the second device rather than loading the web application.

When a main device such as an IPTV client has been inactive for a long period, the session for the IPTV client expires. This would mean that the second device that is used to browse and search the content on behalf of the IPTV client will not be able to continue with its browsing and searching. Further, even if the second device is able to continue browsing and searching, the differences in sessions will result in an error when the IPTV client tries to playback the selected content after the IPTV client becomes active again. When the IPTV client gets a new session, it might disable the current session used by the second device.

In one implementation, a technique addresses the above-described shortcomings when an IPTV client becomes inactive. The technique allows the second device to continue browsing and searching on behalf of the IPTV client even when the IPTV client's session has expired. When the IPTV client becomes active again, security and session credentials are authenticated and transferred from the second device to the IPTV client rather than starting up a new session for the IPTV client. This makes it appear that the IPTV client has been active for the entire time.

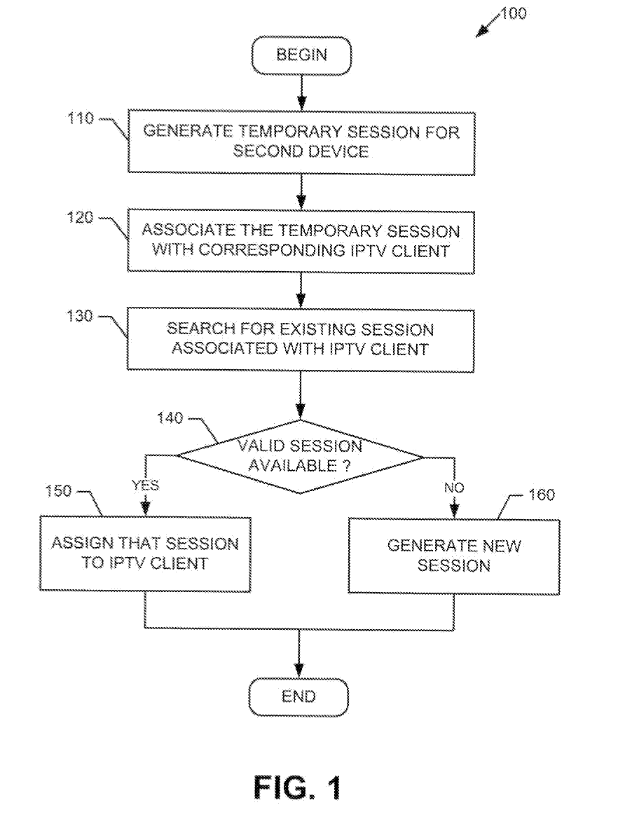

FIG. 1 is a flowchart illustrating a process 100 for synchronizing a session of an inactive IPTV client with a second device in accordance with one implementation of the present invention. When an IPTV client has been inactive for a long period, its session expires. However, a user may be using a second device to browse the BIVL content remote from the IPTV client whose session is expiring or has expired.

In this case, in which the IPTV client session is now stale, the IPTV server generates a temporary session for the second device, at box 110, and associates the temporary session with the corresponding IPTV client, at box 120, to allow the second device to continue browsing. When the IPTV client becomes active again and logs into the system, the IPTV server searches for an existing session (i.e., the temporary session) that is associated with this IPTV client, at box 130. If a valid session is available, at box 140, then that session is assigned to the IPTV client, at box 150. Otherwise, if no valid session is available, a new session is generated and assigned to the IPTV client, at box 160. Therefore, the process 100 shown in the illustrated implementation of FIG. 1 allows BIVL transactions made by second device while the IPTV client was offline tit) be valid in the session assigned to the IPTV client when the IPTV client becomes active again.

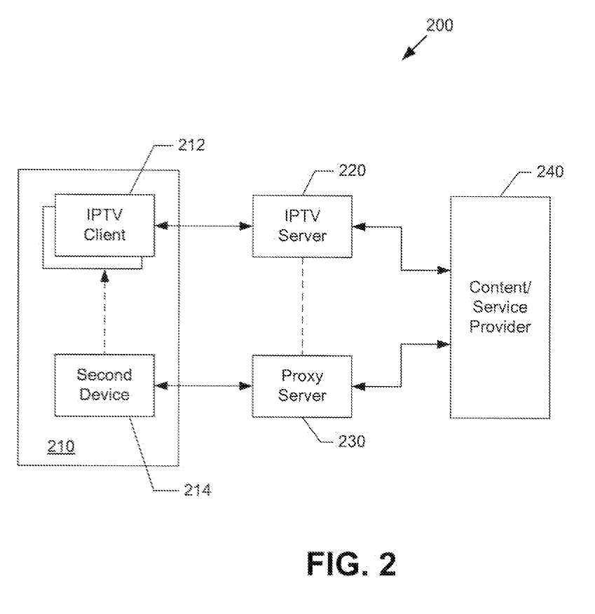

FIG. 2 shows a content transaction system 200 configured a enabling a user browsing media content on one device to have the selection played by another device. In one implementation, the content transaction system 200 includes an IPTV client 212 and a second device 214 configured within a local network 210, which are in communication with an IPTV server 220 and a proxy server 230. The servers 220, 230 are in communication with a content/service provider 240.

The user loads a web application in the second device 214 and logs into an account in the proxy server 230. In an alternative, the user can use a native application already installed on the second device to log into the proxy server account. Once logged into the account, the second device 214 receives a list of compatible IPTV clients 212. Using the second device, the user selects an IPTV client 212. A list of services available to the client 212 is shown on the display of the second device 214. The user can browse and search services and content in the preferred language of the user. For security reasons, BIVL content transaction between the second device 214 and the content/service provider 240 occurs on the proxy server 230 to create a firewall. When content is selected by the user using the second device 214, the content will be sent to the IPTV client 212 for playback. However, the second device 214 sends only a reference identifier for the selected content to the IPTV client 212, which retrieves the content using the reference identifier.

The authenticated IPTV client 212 sends the reference identifier to the IPTV server 220 which in turn sends it to the content/service provider 240. The IPTV client 212 receives the content selected by the second device 214 from the content/service provider 240 through the IPTV server 220. Thus, the unauthenticated second device 214 is not given access to the content URL to reduce the risk of exposing proprietary information. During playback, the user using the second device 214 continues to browse, search, select, and queue other content for future playback without interrupting the content that is being played on the IPTV client 212. In one implementation, both the selected IPTV client 212 and the second device 214 must be in the same local network 210 in order to perform a playback of the selected content. The user can also switch clients 212 and resume playback on a different client by selecting from a recently viewed list of the last media content played and after switching control to that device.

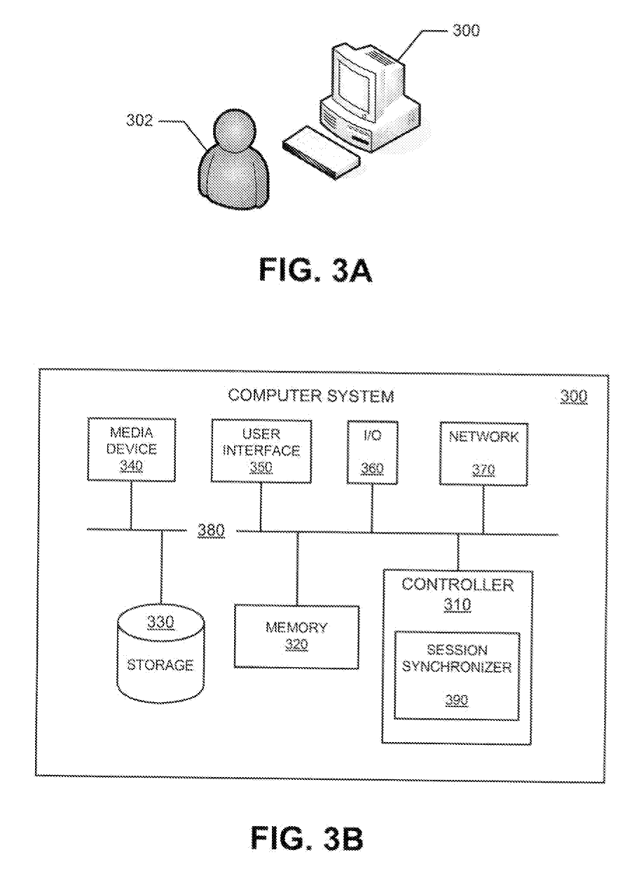

FIG. 3A illustrates a representation of a computer system 300 and a user 302. The user 302 uses the computer system 300 to synchronize a session of an inactive IPTV client with a corresponding second device. The computer system 300 stores and executes a session synchronizer 390.

FIG. 3B is a functional block diagram illustrating the computer system 300 hosting the session synchronizer 390. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the session synchronizer 390 as a software system. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Storage 330 stores data temporarily or long term for use by other components of the computer system 300, such as for storing data used by the session synchronizer 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user of the computer system 300 and presenting information to the user. In one implementation, the user interface 350 includes a keyboard, a mouse, audio speakers, and a display. The controller 310 uses input from the user to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 302.11) supporting an Ethernet connection.

The computer system 300 includes additional hardware and software typical of computer systems (e.g., power, cooling, operating system), though these components are not specifically shown in FIG. 3B or simplicity. In other implementations, different configurations of the computer system can be used (e.g., different bus or storage configurations or a multi-processor configuration).

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Accordingly, additional implementations and variations are also within the scope of the invention. For example, the examples focus on an IPTV client and browsing of the BIVL content, but devices other than an IPTV client can be used as a main display device and the second device can browse and search for content other than the BIVL content. Further, it is to be understood that the description and drawings presented herein are representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A method of synchronizing a session of an inactive first device with a second device, the method comprising:
generating a temporary session for the second device when the first device configured as an IPTV client becomes inactive;
associating the temporary session with the inactive IPTV client to allow the second device to continue transactions while the IPTV client is inactive;
searching for the temporary session associated with the IPTV client when the IPTV client becomes active again; and
assigning the temporary session to the IPTV client.

2. The method of claim 1, further comprising
validating the transactions made by the second device while the IPTV client was inactive when the IPTV client becomes active again.

3. The method of claim 1, wherein the second device comprises
one of cellphone, laptop, and other portable device.

4. The method of claim 1, wherein the transactions made by the second device comprise browsing, searching, and selecting media content.

5. The method of claim 4, further comprising
sending the selected media content to the IPTV client for playback.

6. The method of claim 5, wherein sending the selected media content to the IPTV client comprises
sending only a reference identifier for the selected media content to the IPTV client.

7. The method of claim 6, further comprising.
retrieving and downloading the selected media content by the IPTV client using the reference identifier,
wherein access to the selected media content by the second device is only through the reference identifier.

8. The method of claim 1, wherein the IPTV client and the second device are configured as residing within one local network.

9. The method of claim 1, further comprising
enabling the second device to load a web application, and to log into an account in a proxy server.

10. The method of claim 9, further comprising
sending a list of compatible IPTV clients from the proxy server.

11. The method of claim 10, further comprising
enabling the second device to select an IPTV client from the list of compatible IPTV clients.

12. The method of claim 9, further comprising
displaying a list of services available to the IPTV client on the display of the second device.

13. A non-transitory storage medium storing a computer program for synchronizing a session of an inactive first device with a second device, the computer program comprising executable instructions that cause a computer to:
generate a temporary session for the second device when the first device configured as an IPTV client becomes inactive;
associate the temporary session with the inactive IPTV client to allow the second device to continue transactions while the IPTV client is inactive;
search for the temporary session associated with the IPTV client when the IPTV client becomes active again; and
assign the temporary session to the IPTV client.

14. The non-transitory storage medium of claim 13, further comprising executable instructions that cause a computer to:
validate the transactions made by the second device while the IPTV client was inactive when the IPTV client becomes active again.

15. The non-transitory storage medium of claim 13, wherein the transactions made by the second device comprise browsing, searching, and selecting media content.

16. The non-transitory storage medium of claim 15, further comprising executable instructions that cause a computer to:
send the selected media content to the IPTV client for playback.

17. The non-transitory storage medium of claim 16, wherein executable instructions that cause a computer to send the selected media content to the IPTV client comprise executable instructions that cause a computer to:
send only a reference identifier for the selected media content to the IPTV client.

18. The non-transitory storage medium of claim 17, further comprising executable instructions that cause a computer to:
retrieve and download the selected media content by the IPTV client using the reference identifier,
wherein access to the selected media content by the second device is only through the reference identifier.

19. The non-transitory storage medium of claim 13, further comprising executable instructions that cause a computer to:
load a web application, and to log into an account in a proxy server.

20. The non-transitory storage medium of claim 19, further comprising executable instructions that cause a computer to:
send a list of compatible IPTV clients from the proxy server.

21. The non-transitory storage medium of claim 20, further comprising executable instructions that cause a computer to:
enable the second device to select an IPTV client from the list of compatible IPTV clients.
